(19) United States
(12) Patent Application Publication
(10) Pub. No.: US 2017/0264691 A1
(43) Pub. Date: Sep. 14, 2017

(54) VIRTUAL VEHICLE SENSORS AND PERIPHERALS BASED ON ADD-ON DEVICE CAPABILITY

(71) Applicant: GM Global Technology Operations LLC, Detroit, MI (US)

(72) Inventors: Fan Bai, Ann Arbor, MI (US); Dan Shan, Troy, MI (US); Lakshmi V. Thanayankizil, Rochester Hills, MI (US); David P. Pop, Garden City, MI (US)

(21) Appl. No.: 15/064,022

(22) Filed: Mar. 8, 2016

(51) Int. Cl. H04L 29/08; G07C 5/00; H04L 29/06; G06F 13/10

(52) U.S. Cl. CPC H04L 67/125; G06F 13/102; G07C 5/008; H04L 67/42

(57) ABSTRACT

A transportation-vehicle system for use in virtualizing sensor data from an add-on device for use by a vehicle application. The system includes a hardware-based processing unit and a computer-readable storage device. The storage includes (i) a virtual-sensor-arrangement client configured to communicate with a virtual-sensor-arrangement server of the add-on device, including receiving, from the virtual-sensor-arrangement server, the sensor data corresponding to sensing performed at a sensor of the add-on device. The add-on device is not a part of the transportation vehicle as originally manufactured. The storage also includes (ii) a virtual input/output device driver configured to, when executed by the processing unit, process the sensor data received, yielding virtualized sensor data for delivery to the vehicle application. The technology also includes processes for making and using the system for virtualizing sensor data from an add-on device for use by a vehicle application.

### TECHNICAL FIELD

The present disclosure relates generally to leveraging capabilities of an add-on device at a vehicle platform and more particularly to systems and processes for leveraging sensing capabilities of the add-on device to enhance vehicle performance or user experience.

### BACKGROUND

This section provides background information related to the present disclosure which is not necessarily prior art.

Modern transportation vehicles such as automobiles are equipped with numerous processing and sensing capabilities not available in prior generations of vehicles. Once each vehicle is made, its sensing capabilities are limited to the original sensor hardware installed, though.

Aftermarket upgrades or retrofits are possible, but require undesirably high costs for new hardware, underlying software, labor, and time, and in some cases may adversely affect vehicle aesthetics.

Products exist allowing a vehicle screen to mirror a smartphone screen, and the vehicle screen to be used to control the smartphone. But these products are limited to these functions, being configured only to transfer low-frequency and low-throughput query/reply data.

### SUMMARY

The present technology solves these and other challenges by leveraging sensing capabilities of one or more mobile or otherwise connectable devices, such as a smart phone, at a vehicle such as an automobile, an aircraft, or marine craft.

In one aspect, the technology relates to a transportation-vehicle system, for use in virtualizing sensor data from an add-on device for use by an application running at the vehicle. Examples of add-on devices include but are not limited to smartphones, dongles/gadgets that can be plugged into USB or OBD ports of the vehicle, wearable devices like smart watches, personal computers, Internet of Thing (loT) devices, and sensors or modules within or otherwise of another vehicle, sensors or modules on the road, in the building, or in the sky (X2V).

The system in various embodiments includes a computer-readable storage device having (i) a virtual-sensor-arrangement client configured to, when executed by a processing unit, communicate with a virtual-sensor-arrangement server of the add-on device. Communications include the client receiving, from the virtual-sensor-arrangement server, the sensor data corresponding to sensing performed at a sensor of the add-on device. In many cases, the add-on device is not a part of the transportation vehicle as originally manufactured. The storage device further has (ii) a virtual input/output device driver configured to, when executed by the processing unit, process the sensor data received, yielding virtualized sensor data for delivery to the vehicle application. In various embodiments, the hardware-based processing unit is part of the system.

In some embodiments, the computer-readable storage device comprises a control plane module configured to determine whether the sensor of the add-on is known or unknown to the transportation-vehicle system based on pre-established code of the transportation-vehicle system. Further operations include, if unknown, facilitating procurement from the add-on device of code configured to establish the virtual input/output device driver at the transportation-vehicle system. Or, if known, initiate establishment of the virtual input/output device driver at the transportation-vehicle system using the pre-established code.

In various embodiments, the sensor is selected from a group consisting of an add-on-device barometer, an add-on-device camera, an add-on-device accelerometer, an add-on-device gyroscope sensor, and an add-on-device biometric sensor, or other sensors of the add-on device.

The virtual input/output device driver, in being configured to process the sensor data, is configured in some cases to open, read, configure, and/or write the sensor data. Other processing functions can include setting, mapping, and/or establishing callback functions.

The storage device in various embodiments also includes a control plane module configured to communicate with an input/output capability-mapping module of the add-on device to determine whether the add-on device is configured to provide sensor output within one or more pre-established parameters of the transportation-vehicle system. Example parameters include a data-sampling rate, a data-sensing accuracy measure, a data-transmission latency, and a data format.

The storage device in various embodiments also includes a control plane module configured to facilitate formation of the virtual input/output device driver and a virtual input/output device file to store data processed by the virtual input/output device drive in operation of the transportation-vehicle system. The control plane can be, in being configured to facilitate formation of the virtual input/output device driver and the virtual input/output device file, configured to determine whether an operating system associated with the transportation-vehicle system includes code configured to establish the virtual input/output device driver and the virtual input/output device file. And the control plane module, or vehicle-system control plane can be configured to, in response to determining that the operating system does not include the code configured to establish the virtual input/output device driver and the virtual input/output device file, communicate with an add-on-device control plane to arrange transmitting, from the add-on-device to the transportation-vehicle system, code for establishing the virtual input/output device driver and the virtual input/output device file at the transportation-vehicle system.

In various embodiments, the storage device further includes a permissions module, wherein the control plane is configured to, using the permissions module, determine whether permission exists to, at the transportation-vehicle system, use the sensor data from the add-on device. The control plane, or vehicle-system control plane, and/or the permissions module, or vehicle-system permissions module, in determining whether permission exists to use the sensor data from the add-on device, are configured to communicate with an add-on-device control plane and add-on-device permissions module.

In another aspect, the technology relates to a process, to be performed at a transportation vehicle including a virtual-sensor-arrangement client and a virtual input/output device driver. The process includes (a) executing, by a tangible transportation-vehicle system having a hardware-based processor executing instructions stored on a non-transitory computer-readable storage device, an application requiring input from a particularly type of sensor. The process further includes (b) facilitating, by the tangible transportation-vehicle system, communication between the virtual-sensor-arrangement client, of the vehicle, and a virtual-sensor-arrangement server, of an add-on device, wherein the add-on device includes an add-on-device sensor of, or having, the particularly type and is not a part of the transportation vehicle as the vehicle was originally manufactured.

The process can further include (c) obtaining, by the tangible transportation-vehicle system, from the add-on device, sensor output from the add-on-device sensor, and (d) processing the sensor output, by the tangible transportation-vehicle system, using the virtual input/output device driver of the transportation vehicle, yielding virtualized sensor data. The process also includes (e) providing the processed sensor data to the application as the required input.

In various embodiments, usage (e.g., computing and processing) of sensory data, for the purpose of enabling a corresponding at-vehicle app, is conducted at the side of the transportation vehicle, while the usage at the add-on device side is fairly limited to nil. This is in stark contrast to the mentioned simple mobile-device screen mirroring (or, ‘phone projection’) mentioned in the Background section, above.

In some embodiments, the vehicle system and add-one device are configured so that the roles are switched. That is, the client-side is at the add-on device and the server-side is at the vehicle, whereby the add-on device, and an app running at the device, leverage vehicle-sensor data. For example, the client-side virtual-sensor arrangement, including the client, the virtual input/output device driver and file, are provided at the add-on device and in operation receives, via the client at the add-on device, vehicle-sensor data and virtualizes the data at the add-on device for use by one or more apps running at the add-on device. The relevant vehicle sensor(s) can include any modern vehicle sensor, such as a radar or other range sensor. The vehicle sensor can include any sensor or sensors mentioned herein primarily as example add-on device sensors (e.g., the vehicle sensor leveraged by the add-on device can include a vehicle IMU sensor, a vehicle barometer, a vehicle camera, etc.). Accordingly, all of the disclosure herein regarding the first implementations, whereby the client and related structures are at the vehicle system (see e.g., FIG. 5), are considered to hereby also separately disclose corresponding implementations in which they are at the add-on device—these other, second, implementations are not shown in detail in the figures and described in the interest of brevity, as the present disclosure and reference are sufficient to convey the structures and functions provided.

In a contemplated embodiment, each device is configured to leverage, or virtualize and use, sensor data from the other. Each can include a server and a client, for instance, or a structure could be configured at each capable of performing respective server and client duties. Accordingly, all of the disclosure herein regarding the first and second implementations, are considered to hereby also separately disclose corresponding third implementations in which both the vehicle system and the add-on device have the client and server structure and functions—the third implementations are not shown in detail in the figures and described in the interest of brevity, as the present disclosure and reference are sufficient to convey the structures and functions provided.

In various implementations, the transportation vehicle is not equipped with the particularly type of sensor.

The transportation vehicle in various implementations includes a virtual input/output device file, and processing the sensor output, by the tangible transportation-vehicle system, can include using the virtual input/output device file and the virtual input/output device driver of the transportation vehicle, yielding the virtualized sensor data.

The process can also include communicating with an input/output capability-mapping module of the add-on device to determine whether the add-on device provides sensor output within one or more pre-established parameters of the transportation-vehicle system.

Other aspects of the present technology will be in part apparent and in part pointed out hereinafter.

### DESCRIPTION OF THE DRAWINGS

FIG. 1 illustrates schematically an example vehicle computer in communication with a mobile device.

FIG. 2 shows example memory components of the computer architecture of FIG. 1.

FIG. 3 shows schematically the example add-on device communicative with the vehicle computer in FIG. 1.

FIG. 4 shows example memory components of the architecture of FIG. 3

FIG. 5 shows select components and communications of the computers of FIGS. 1 and 3.

FIG. 6 shows a first exemplary algorithm in the form of a process flow, for performing first functions, for establishing a virtualizing infrastructure.

FIG. 7 shows a second exemplary algorithm for performing second, sensor-virtualization, functions.

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

I. Introduction

The present technology by various embodiments leverages sensing capabilities of one or more mobile or otherwise connectable devices, such as a smart phone, at a vehicle such as an automobile, an aircraft, or marine craft.

A unique architecture incorporates a plug-in or wireless sensor device into vehicle operations. Benefits include but are not limited to improving vehicle performance of functions relying on sensor or sensor peripheral feedback, enhancing vehicle-user interaction, and/or enabling implementation at the vehicle of advanced computing applications requiring sensing capabilities that the vehicle would not have otherwise.

In various embodiments, a sensor peripheral, or sensing peripheral, of an add-on device, includes at least one sensor and associated hardware and/or software used in performance or output processing of the underlying sensor(s). While the term sensor is used mainly throughout regarding add-on device sensing capabilities, the references also incorporate embodiments in which a sensing peripheral is also used, or used instead of just sensor, unless stated otherwise.

The technology allows effective and relatively inexpensive addition of common, or known, sensors or sensor peripherals, and uncommon, or unknown, sensors or sensor peripherals, and without requiring changes to most or all basic on-board computer (OBC) features, such as vehicle operating system (OS) and related drivers.

Add-on sensors or sensor peripherals can be provided by a smartphone or other off-the-shelf (OTS) devices. The add-on device can be arranged in the vehicle in any appropriate manner, such as being secured in a bracing apparatus (not shown) and facing forward through the windshield when a forward-viewing camera is being virtualized.

While the present technology is described primarily herein in connection with automobiles, the technology is not limited by the focus. The concepts can be extended to a wide variety of applications, such as aircraft and marine craft, as mentioned, and any other computing apparatus that uses sensing technology and would benefit from upgraded sensing capabilities at relatively low cost, financially and in terms and time, labor, and materials.

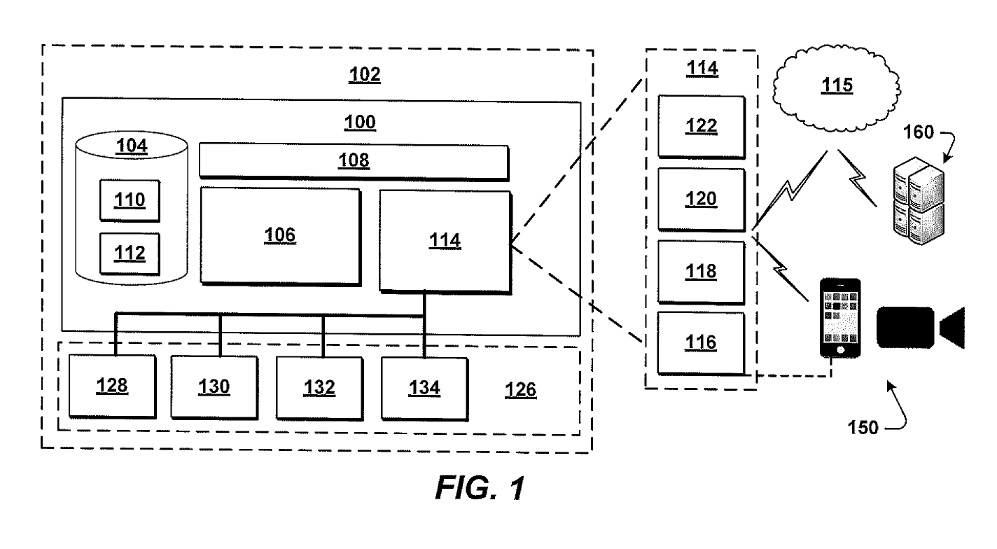

II. FIG. 1—On-Board Computing Architecture

Turning now to the figures and more particularly the first figure, FIG. 1 illustrates a hardware-based computing or controlling apparatus 100. The controlling apparatus 100 can be referred to by other terms, such as computing apparatus, controller, controller apparatus, the like, or other.

The controller apparatus 100 is in various embodiments part of a greater system 102, such as a vehicle. The controller apparatus 100 can be, be a part of, include, or be in communication with an on-board computer (OBC), an electronic control unit (ECU), or other computing apparatus of the greater system 102—for example, a vehicle, such as an automobile.

The hardware-based controlling apparatus 100 includes a hardware-based computer-readable storage medium, or data storage device 104 and also includes a hardware-based processing unit 106 connected or connectable to the computer-readable storage device 104 by way of a communication link 108, such as a computer bus or wireless structures.

The hardware-based processing unit 106 can be referenced by other names, such as processor, processing hardware unit, the like, or other.

The hardware-based processing unit 106 can include or be multiple processors, which could include distributed processors or parallel processors in a single machine or multiple machines. The hardware-based processing unit 106 can be used in supporting a virtual processing environment.

The hardware-based processing unit 106 could include a state machine, application specific integrated circuit (ASIC), programmable gate array (PGA) including a Field PGA, or state machine. References herein to the hardware-based processing unit executing code or instructions to perform operations, acts, tasks, functions, steps, or the like, could include the hardware-based processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

The term computer-readable media and variants thereof, as used in the specification and claims, refer to tangible storage media. The media can be a device, and can be non-transitory.

In some embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The data storage device 104 includes one or more storage modules 110 storing computer-readable code or instructions executable by the hardware-based processing unit 106 to perform the functions of the hardware-based controlling apparatus 100 described herein.

The data storage device 104 in some embodiments also includes ancillary or supporting components 112, such as additional software and/or data supporting performance of the processes of the present disclosure, such as one or more user profiles or a group of default and/or user-set preferences.

The hardware-based controlling apparatus 100 also includes a communication sub-system 114 for communicating with one or more local and/or external networks 115, such as the Internet, or remote systems 160.

The communication sub-system 114 in various embodiments includes any of a wire-based transceiver 116, at least one long-range wireless transceiver 118, and one or more short- and/or medium-range wireless transceivers 120. Another port 122 is shown by way of example to emphasize that the system can be configured to accommodate one or more other types of wired or wireless communications.

The long-range transceiver 118 is in some embodiments configured to facilitate communications between the hardware-based controlling apparatus 100 and a satellite and/or a cellular telecommunications network, which can be considered also indicated schematically by reference numeral 115.

The short-range transceiver 120 is configured to facilitate short-range communications, such as communications with other vehicles, in vehicle-to-vehicle (V2V) communications, and communications with transportation system infrastructure (V2I).

To communicate V2V, V2I, or with other extra-vehicle devices, such as local communication routers, etc., the short-range communication transceiver 120 may be configured to communicate by way of one or more short-range communication protocols. Example protocols include Dedicated Short-Range Communications (DSRC), WI-FI®, BLUETOOTH®, infrared, infrared data association (IRDA), near-field communications (NFC), the like, or improvements thereof (WI-Fl is a registered trademark of WI-Fl Alliance, of Austin, Tex.; BLUETOOTH is a registered trademark of Bluetooth SIG, Inc., of Bellevue, Washington).

By short- and/or long-range wireless communications, the hardware-based controlling apparatus 100 can, via the communication sub-system 114 and the processor 106, send and receive information, such as in the form of messages or packetized data, to and from the one or more communication networks 115.

External devices 160 with which the sub-system 114 communicates are in various embodiments nearby, remote, or both.

External or extra-vehicle devices to which the hardware-based controlling apparatus 100 can communicate with, in performance of functions of the present technology, include one or more local add-on device 150, such as a user smartphone, or other local device having at least one relevant sensor or sensor peripheral configured to provide output that can be used by the vehicle 102, by existing vehicle functions and/or functions that the vehicle can perform using new software—e.g., applications—and the new sensor output.

An example vehicle function is autonomous driving, which can rely in part on vehicle-camera data, such as from a camera 128, shown schematically in FIG. 1. The vehicle 102 can, according to the present technology, use visual data from the add-on device 150 camera, in addition to or instead of the existing vehicle-camera data.

External or extra-vehicle devices can also include a remote system 160, such as a server (e.g., application server) or data, customer-service, and/or control center, which can be reachable by the indicated network(s) 115.

An example control center is the OnStar® control center, having facilities for interacting with vehicles and users, whether via the vehicle or otherwise (e.g., mobile phone) via long-range communications, such as satellite or cellular communications. ONSTAR is a registered trademark of the OnStar Corporation, which is a subsidiary of the General Motors Company.

The vehicle 102 also includes a sensor/peripheral sub-system 126 comprising sensors or sensor peripherals providing information to the hardware-based controlling apparatus 100 regarding items such as vehicle operations, vehicle position, vehicle pose, and/or the environment about the vehicle 102. The arrangement can be configured so that the hardware-based controlling apparatus 100 communicates with, or at least receives signals from sensors of the sensor sub-system 126, via wired or short-range wireless communication links 116, 120.

In various embodiments, the sensor sub-system 126 includes at least one camera 128 and at least one range sensor 130, such as radar. The camera 128 may include a monocular forward-looking camera, such as those used in lane-departure-warning (LDW) systems. Other embodiments may include other camera technologies, such as a stereo camera or a trifocal camera.

Such sensor sensing external conditions may be oriented in any of a variety of directions without departing from the scope of the present disclosure. For example, cameras 128 and radar 130 may be oriented at each, or a select, position of, for example, (i) facing forward from a front center point of the vehicle 102, (ii) facing rearward from a rear center point of the vehicle 102, (iii) facing laterally of the vehicle from a side position of the vehicle 102, and/or (iv) between these directions, and each at or toward any elevation.

Accordingly, the descriptions below, made primarily with respect to forward-facing sensors, may be applied with respect to rearward and/or side facing sensors, independently or in combination with forward-facing sensors.

The range sensor 130 may include a short-range radar (SRR), an ultrasonic sensor, a long-range RADAR, such as those used in autonomous or adaptive-cruise-control (ACC) systems, or a Light Detection And Ranging (LiDAR) sensor, for example.

Other sensor sub-systems include an inertial-momentum unit (IMU) 132, such as one having one or more accelerometers, and/or other such dynamic vehicle sensors 134, such as a wheel sensor or a sensor associated with a steering system (e.g., steering wheel) of the vehicle 102.

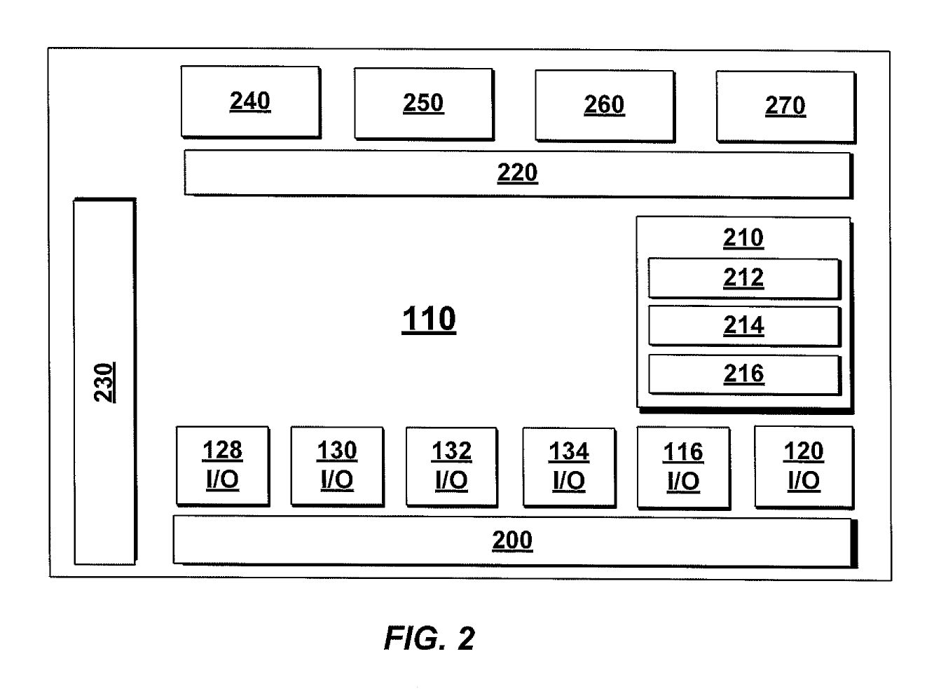

III. Vehicle Data Storage—FIG. 2

FIG. 2 shows in more detail some of the features of the data storage device 104 of the vehicle 102 of FIG. 1.

As mentioned, instructions or code of the data storage device 104 can be arranged in one or more modules 110.

The data storage device 104 may also include ancillary components 112 (FIG. 1), such as additional software and/or data supporting performance of the processes of the present disclosure. The ancillary components can include, for example, additional software and/or data supporting performance of the processes of the present disclosure, such as one or more user profiles or a group of default and/or user-set preferences.

Any of the code or instructions described can be part of more than one module. And any functions described herein can be performed by execution of instructions in one or more modules, though the functions may be described primarily in connection with one module by way of primary example. Each of the modules or sub-module thereof can be referred to by any of a variety of names, such as by a term or phrase indicative of its function.

As just an example, instructions configured to, via the hardware-based processing unit 106, obtain from an add-on device driver code for creating a virtual device driver at the vehicle 102, can be referred to as a driver-procurement module, or the like. As another example, instruction configured to obtain permissions from the operating system (200) of the vehicle 102 for using code at the virtual device driver created, can be referred to as a vehicle permissions module, or the like.

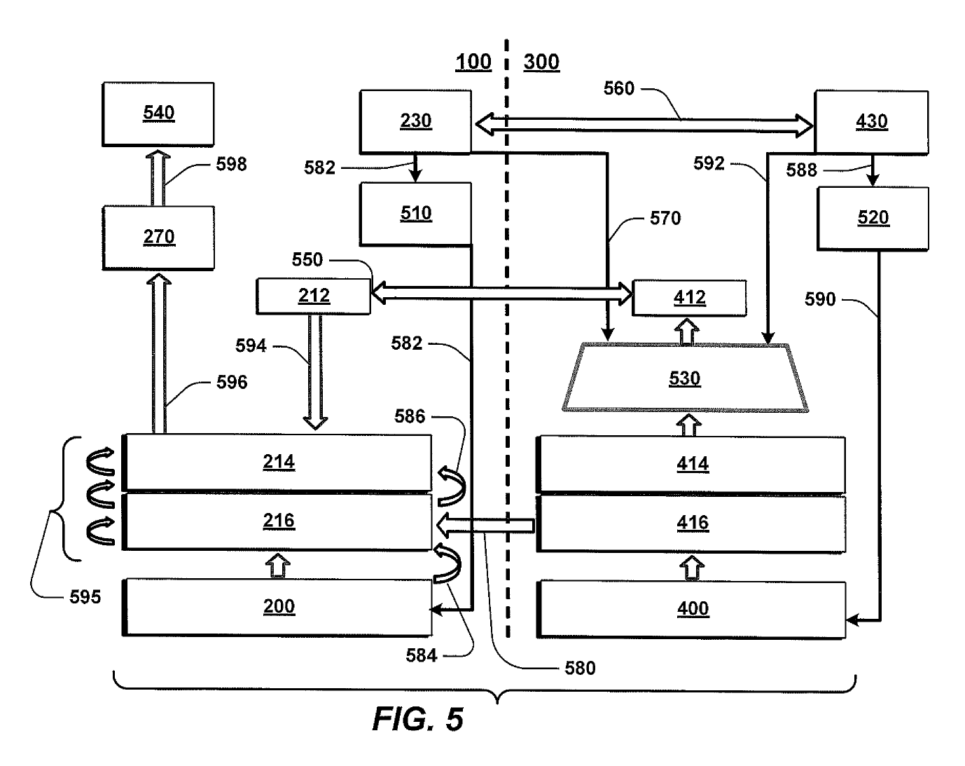

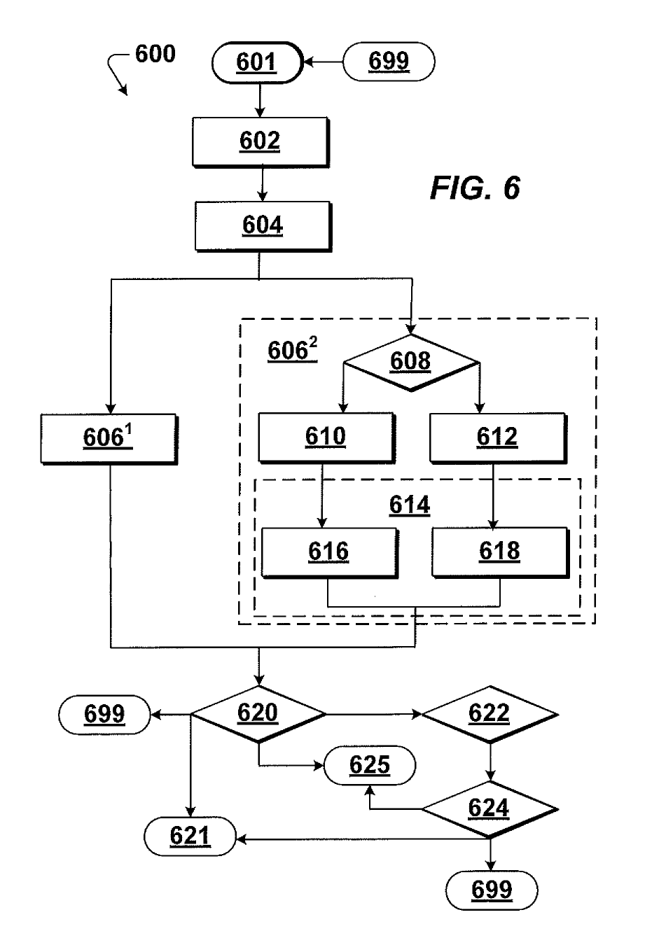

Some of the functions of the components of FIGS. 1 and 2 are provided in this section, and others below in connection with the diagram of FIG. 5 and algorithm of FIG. 6.

The code or modules 110 includes an operating system 200, and multiple input and/or output components 116 I/O, 120 I/O, 128 I/O, 130 I/O, 132 I/O, and 134 I/O. The input/ output components correspond to system ports for respective system inputs mentioned—116 (vehicle wired transceiver(s)), 120 (vehicle short or medium-range wireless transceiver(s)), 128 (vehicle camera(s)), 130 (vehicle range sensor(s)), 132 (vehicle IMU(s)), and 134 (vehicle dynamics sensor(s)).

The code 110 further includes a virtual input/output (I/O) service 210 comprising a vehicle-side client 212. The service 210 can be referred to as middleware.

The virtual I/O service 210 can further include or be in communication with a virtual input/output (I/O) device file 214 and a virtual input/output (I/O) device driver 216. The service, driver, and file 210, 216, 214 are referred to using the term virtual because they are used in presenting a virtual sensor, in that the actual, underlying, sensing sensor is not present at the vehicle; the service, driver, and file are not virtual, themselves. Similarly, other references to virtual, virtualizing, virtualized, or the like (e.g., virtualizing sensor data), does not indicate that the thing referred to is itself virtual (e.g., that the sensor data is, itself, virtual), but is referred to as such because it is associated with presenting a virtual sensor based on output from an actual, underlying, sensing sensor that is not present at the vehicle

The virtual I/O service 210 is shown positioned adjacent the wired and wireless inputs/outputs 116, 120 because inputs/outputs to/from the service 210 would in various configurations be passed by those channels.

Code 110 components further include input/output (I/O) application program interfaces 220 (APIs) for various applications 240, 250, 260, 270 operating at the vehicle 102. While four applications are shown by way of example, the code 110 can include or be in communication with any number of applications that can benefit from operations of the present technology.

The code 110 also includes a control plane 230. The control plane 230 can perform functions such as initiating, arranging, orchestrating, and/or managing operations within the system 100, such as regarding actions and interactions at and between any of the operating system 200, input/outputs (e.g., 128, 130, etc.), features of the virtual i/o service 210, and input/output APIs 220. The initiated, arranged, orchestrated and/or managed operations can be referenced as operations of a data plane.

Particular control plane 230 functions can also in various embodiments be performed via communications with a permissions module (510, FIG. 5) of the code 110 and with an I/O capability-mapping module (530, FIG. 5) of the add-on device 150, as described further below regarding FIGS. 5 and 6.

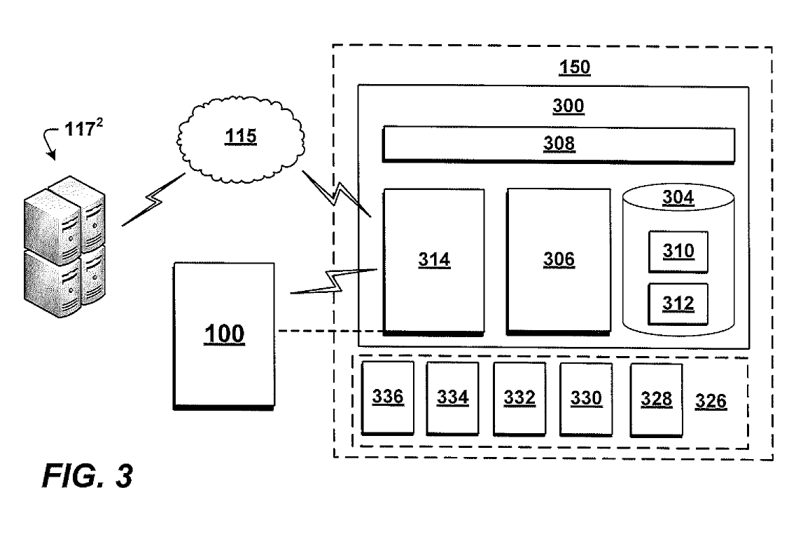

IV. Add-on Device—FIG. 3

FIG. 3 illustrates schematically the example add-on device 150 shown in FIG. 1.

The add-on device 150 can be referred to by other terms, such as a user device, a local device, an add-on device, a plug-in device, an ancillary device, system, or apparatus. The term add-on device 150 is used primarily herein because the device 150 is not an original part of the greater system 102, such as an automobile, with which the device 150 is used.

The add-on device 150 includes a computing architecture or add-on-computing device 300, including any of the features provided for the system 100 of FIG. 1, by way of example. The computing architecture 300 can be referred to by a variety of terms, such as hardware-based add-on controlling apparatus.

The add-on-computing device 300 includes a hardware-based computer-readable storage medium, or data storage device 104 and also includes a hardware-based processing unit 306 connected or connectable to the computer-readable storage device 304 by way of a communication link 308, such as a computer bus or wireless structures.

The hardware-based processing unit 306 can be referenced by other names, such as processor, processing hardware unit, the like, or other.

The hardware-based processing unit 306 can be in any way like the unit 106 described above in connection with FIG. 1.

The data storage device 304 can be in any way like the device 104 described above in connection with FIG. 1. For example, the data storage device 304 can include one or more storage modules 310 storing computer-readable code or instructions executable by the hardware-based processing unit 306 to perform the functions of the hardware-based controlling apparatus 100 described herein.

The data storage device 304 in some embodiments also includes ancillary or supporting components 312, such as additional software and/or data supporting performance of the processes of the present disclosure, such as one or more user profiles or a group of default and/or user-set preferences.

The add-on-computing device 300 also includes a communication sub-system 314 for communicating with the first computing system 100—such as by wired or wireless connections, one or more local or external networks 115, such as the Internet, or remote systems 160.

The communication sub-system 314 in various embodiments includes any of a wire-based transceiver or port, at least one long-range wireless transceiver, and one or more short- and/or medium-range wireless transceivers. The wired port can include, for instance, a universal-serial-bus (USB) port.

The long-range transceiver is in some embodiments configured to facilitate communications between the add-on-computing device 300 and a satellite and/or a cellular telecommunications network, which can be considered also indicated schematically by reference numeral 115.

The short-range transceiver is configured to facilitate short-range communications, such as communications with other nearby wireless devices, systems, or networks.

Example communication protocols include Dedicated Short-Range Communications (DSRC), WI-Fl®, BLUETOOTH®, infrared, infrared data association (IRDA), near field communications (NFC), the like, or improvements thereof.

By short- and/or long-range wireless communications, the add-on-computing device 300 can, via the communication sub-system 314 and the processor 306, send and receive information, such as in the form of messages or packetized data, to and from the one or more communication networks 315.

The add-on device 150 also includes a sensor sub-system 326 comprising sensors providing information to the add-on-computing device 300, such as about an environment of the add-on device 150.

The arrangement can be configured so that the add-on controlling apparatus 300 communicates with, or at least receives signals from sensors of the sensor sub-system 326, via wired or short-range wireless communication links.

Original vehicle sensors are generally domain-specific for a vehicle function and therein configured and arranged for a specific purpose by having robust calibration and customization for the function. New applications being developed for vehicles continuously, though, require or would benefit from one or more sensing capabilities that a vehicle may not already have.

Add-on devices 150 such as smartphones and OTS devices could have the required or preferred sensors, or sensors having better characteristics over sensors that the vehicle is originally equipped with, lending to improved performance of the new application. Add-on-device sensors could have higher resolution or accuracy, for instance.

In various embodiments, the add-on-device sensor sub-system 326 includes at least one camera 328, such as a three-dimensional (3D) camera or peripheral, or peripheral system, and at least one microphone 330. Another example sensor is an inertial-momentum unit (IMU) 332, such as one having one or more (e.g., 3D accelerometers). Another example sensor is a barometer, or barometric sensor 334.

Another icon 336 is provided to indicate one or more other sensors that the add-on device 150 can include. Other example sensors include a geo-location receiver, a gyroscope sensor, an altimeter, other accelerators, magnetometer, proximity, light sensor, touch sensor, NFC or other wireless transceiver/detector, and a biometric sensor, —e.g., voice recognition, finger or thumb-print recognition, breathalyzer, and facial, retina or other recognition sensors.

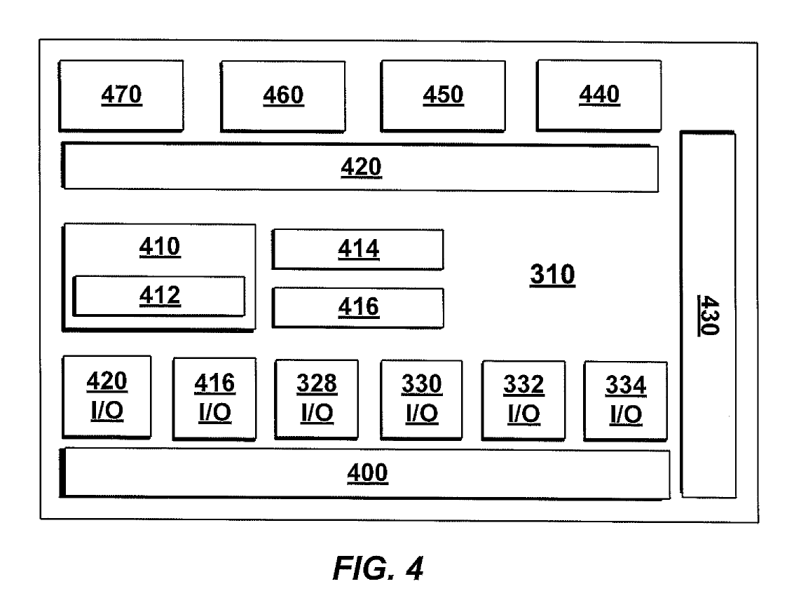

V. Add-on Device Data Storage—FIG. 4

FIG. 4 shows in more detail some of the features of the data storage device 304 of the add-on device 150 of FIG. 3.

As mentioned, instructions or code of the data storage device 304 can be arranged in one or more modules 310. The data storage device 304 may also include ancillary components 312 (FIG. 3), such as additional software and/or data supporting performance of the processes of the present disclosure. The ancillary components can include, for example, additional software and/or data supporting performance of the processes of the present disclosure, such as one or more user profiles or a group of default and/or user-set preferences.

As with the vehicle code, any of the code or instructions of the add-on device 150 described can be part of more than one module. And any functions described herein can be performed by execution of instructions in one or more modules, though the functions may be described primarily in connection with one module by way of primary example. Each of the modules or sub-module thereof can be referred to by any of a variety of names, such as by a term or phrase indicative of its function.

As just an example, instructions configured to, via the hardware-based processing unit 306, send to the vehicle processing unit 106 a device driver code for creating a virtual device driver at the vehicle 102, can be referred to as a driver-processing module, or the like. As another example, instruction configured to obtain permissions from the operating system (400) of the add-on device 150 for using code at the virtual device driver created, can be referred to as an add-on-device permissions module, or the like.

Some of the functions of the components of FIGS. 1-4 are provided in this section, and others below in connection with the diagram of FIG. 5 and algorithm of FIG. 6.

The code or modules 310 includes an operating system 400, and multiple input and/or output components 328 I/O, 330 I/O, 332 I/O, 334 I/O, etc.

The input/ output components correspond to system ports for respective system inputs mentioned - 416 (add-on-device wired transceiver(s), associated with communication sub-system 314), 420 (add-on-device short or medium-range wireless transceiver(s), associated with communication sub-system 314), 328 (add-on-device camera(s)), 330 (add-on-device microphone), 332 (add-on-device IMU(s)), and 334 (add-on-device barometer).

The code 310 further includes a virtual input/output (I/O) service 310 comprising at least an add-on-device -side server 412 corresponding to the virtual I/O service client 212 of the vehicle 102. The virtual I/O service 210 is in various embodiments in communication with an input/output (I/O) device file 414 and an input/output (I/O) device driver 416.

The virtual I/O service 410 is shown positioned adjacent the wired and wireless inputs/outputs 416, 420 because inputs/outputs to/from the service 410 would in various configurations be passed by those channels.

Code 310 components further include input/output (I/O) application program interfaces 420 (APIs) for various applications 440, 450, 460, 470 operating at the add-on device 150. While four applications are shown by way of example, the code 310 can include or be in communication with any number of applications that can benefit from operations of the present technology.

The code 310 also includes a control plane 430. The control plane 430 can perform functions such as initiating, arranging, orchestrating, and/or managing operations within the system 300 (FIG. 3) using the code 310, such as regarding actions and interactions at and between any of the operating system 300, input/outputs (e.g., 328, 330, etc.), features of the virtual i/o service 410, and input/output APIs 420. Particular control plane 430 functions can also in various embodiments be performed via communications with a permissions module (520, FIG. 5) of the code 310 and with the I/O capability-mapping module (530, FIG. 5) of the add-on device 150, as described further below regarding FIGS. 5 and 6. The initiated, arranged, orchestrated and/or managed operations can be referenced as operations of a data plane.

VI. Various Components and Interrelations—FIG. 5

FIG. 5 shows select components of the vehicle 102 and the add-on device 150 of FIGS. 1-4, and example intra- and inter- communications.

Most of the components of FIG. 5 are afore-described, regarding FIGS. 1-4. The components include the permission modules 510, 520, referenced above, regarding the vehicle computing system 100 and the add-on-device computing system 300, respectively.

The components also include the mentioned input/output (I/O) capability-mapping module 530 of the add-on-device computing system 300.

The vehicle 102 also includes one or more receiving apparatus 540, such as a vehicle-user interface—e.g., heads-up display (HUD) or other screen, a vehicle speaker, a vehicle autonomous driving system, a vehicle HVAC system, a communication transceiver for sending a message to a remote device such as a remote customer-service (e.g., OnStar®) server or computer system. The apparatus 540 receives output from an application 270, which is using the virtual I/O data obtained by the virtual-service client 212 from the virtual-service server 412 of the add-on device 150. While a single icon 270 is shown in FIG. 5 regarding applications using the present arrangement, as with all aspects shown, more than one application can use the technology at a time. And while a single icon 540 is shown, as with all features shown, more than one receiving apparatus can be implemented.

In various embodiments, the present architecture is further configured and arranged so that input provided to the interface 540 is received and processed in the system 100 to affect system operations.

In various contemplated embodiments, application output of the application 270 is not limited to output for receipt by the user (e.g., visual or audio), but can include communications to the vehicle 120, such as a message or data package affecting vehicle operations, such as autonomous driving or HVAC settings, and can include communications to a remote system 160, such as an OnStar® server.

Other functions, and communication channels indicated (e.g., 550, etc.), are described further below in connection with the algorithm 600 of FIG. 6.

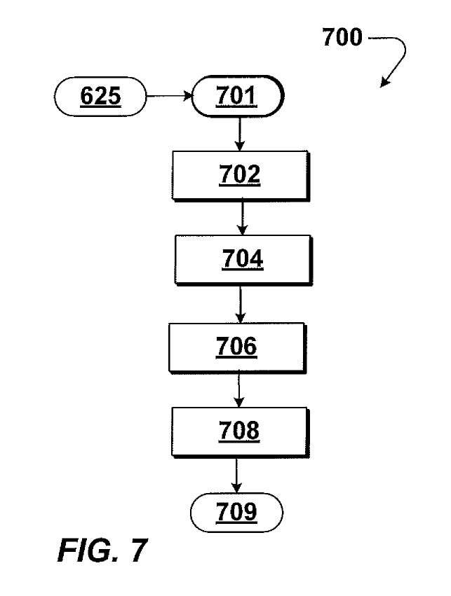

VII. Algorithms—FIGS. 6 and 7

FIGS. 6 and 7 show example algorithms, represented schematically by a process flows 600, 700 for creating and using virtual sensor(s) input at the vehicle 102 based on sensor input from the add-on device 150, according to embodiments of the present technology.

More particularly, FIG. 6 shows a first exemplary algorithm 600 in the form of a process flow, for performing first functions, for establishing a virtualizing infrastructure.

And FIG. 7 shows a second exemplary algorithm 700 for performing second, sensor-virtualization, functions.

In various embodiments, functions of FIG. 6 or 7 can be referred to as virtualizing and/or docking the subject sensor(s) of the add-on device. This in various cases can include accommodating common, or known, sensors and less common or unknown sensors, heretofore not recognized by vehicle code. In various embodiments, the vehicle system 100 is preconfigured with code relating to certain sensors, even if the code is dormant or not used when the vehicle is originally made and put into operation. These sensors can be referred to as common or known sensors. Other sensors, that the vehicle system 100 would not recognize, due to not having pre-established code relating to such sensors, can be referred to as uncommon, or unknown sensors.

It should be understood that the steps, operations, or functions of the algorithms 600, 700 are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated algorithms 600, 700 can be ended at any time.

In certain embodiments, some or all operations of the algorithms 600, 700 and/or substantially equivalent operations are performed by a processor, e.g., computer processor, executing computer-executable instructions stored or included on a computer-readable medium, such as one or both of the data storage devices 104, 304 of the systems 100, 300, or similar features that can be present at a remote server or computer system 160, described above.

VII.A. Algorithm of FIG. 6

The algorithms 600 begins 601 and flow proceeds to block 602, whereat physical connection 550 is established between the hardware-based processing unit 106 of the vehicle 102 and the hardware-based processing unit 306 of the add-on device 150. The connection can be accomplished by wired and/or wireless channels, as referenced above.

At block 604, the vehicle processing unit 106 and the add-on-device processing unit 306 establish a communication channel or channels, for later communications and data transfer between the systems 100, 300—e.g., inter-system communications shown at references 550, 560, 570, 580.

Establishment the communication channel(s) can include a handshake or other introduction or negotiation process. By way of the establishment, the systems 100, 300 can dynamically set parameters of one or more communication channels between them, for example.

At routines 606 (606¹, 602²), any needed and not-present add-on device 150 and vehicle 102 components are provisioned, obtained, or provided.

At block 606¹, the add-on-device-side server 412 and an I/O capability-mapping module 530 are formed.

In various embodiments, the add-on device 150 is specially pre-configured to include the server 412, such as in contemplation of the mating and functions of the present technology. An original equipment manufacturer (OEM) of the vehicle 102 can manufacture or approve such a specially-configured add-on device 150.

The add-on device 150 is also in various embodiments pre-configured with an I/O device file 414 and I/O device driver 416. In the example of a smartphone, for instance, the phone would also have I/O device files and drivers for use in processing output from phone cameras, microphones, IMUs, barometers, and any other phone sensors 328, 330, 332, 334, 336.

By way of example and not limitation, the server 412 and I/O capability-mapping module 530 can be formed by a software update or upgrade received at the add-on device 150 from the remote system 160.

In a contemplated embodiment, the server 412 and I/O capability-mapping module 530 are formed by a software upgrade or update received at the add-on device from the vehicle system 100, such as by way of an application operating at the vehicle system 100, configured in association with the present technology.

In another contemplated embodiment, the server 412 and I/O capability-mapping module 530 are part of an application loaded to the system 300, or are formed by operation of an application loaded to the system 300.

At sub-routine 606², the vehicle-side client 212, and associated virtual I/O service features, including the virtual I/O device file 214 and virtual I/O device driver 216, are created. By way of example and not limitation, the client 212 and I/O structures 214 216 can be formed by a software update or upgrade received from the remote system 160.

At decision diamond 608, of the sub-routine 606, the vehicle processing unit 106 determines whether the vehicle system 100, such as in the operating system 200, includes code, or a basis for rendering code, that can be used to form the virtual I/O device file and driver 214, 216. The operation can include obtaining sensor data indicating a type of sensor of the add-on device 150 to be virtualized at the vehicle system 100. The data can be received from the add-on device 150, or an application running at the vehicle system 100, as examples.

The operating system 200 may have been pre-configured with such pre-existing or dormant code for such purposes. The OEM may have anticipated that an after-market solution, such as retrofit of a common sensor that the vehicle is not equipment originally with, may be provided, and so provided corresponding code. Or the OEM may make certain levels of a vehicle with or without various sensor packages, and decide to leave code, or pre-code, corresponding to included and non-included sensors in all vehicles.

The pre-existing code is more likely to be present, then, in regards to common, or known, sensors. Examples in some embodiments include a simple camera sensor, which can point forward and fill a forward-camera setting in the vehicle system 100 (e.g., dormant code set up for a forward-camera), thought the vehicle is not equipped originally with a forward camera.

As a specific example, an OEM may have provided the operating system or other data structure of the vehicle system 100 with code, or basis for code, corresponding to a front-view camera, though the vehicle 102 was originally equipped with only a rear-view camera, in anticipation of the after-market solution provided by the virtual-front-camera arrangement of the present technology, or a more-expensive actual-vehicle-front-camera after-market solution.

The control plane 230 can orchestrate the decision process including communication with the operating system 200 as indicted by communication path 582 in FIG. 5.

If the vehicle system 100 is found in the decision 608 to include the relevant code or pre-code, flow proceeds to block 610, whereat the virtual I/O device file and/or driver 214, 216 are formed at the vehicle system 100 by the processing unit 106 based on the pre-existing code determined present at the vehicle system 100. The control plane 230 can orchestrate the set-up, such as by communications 582 with the operating system 200.

Relevant functions are indicated by communication paths 584, 586 showing push of relevant code from the source (e.g., operating system 200) to form the virtual I/O device driver and file 216, 214.

In a contemplated embodiment, forming the client 212 and I/O device structures 214 216 is performed in response to a software upgrade or update received at the vehicle system 100 from the add-on device 300, such as by way of an application, configured in association with the present technology, received and operating at the add-on device 300.

If the vehicle system 100 is found in the decision 608 to not include the relevant code or pre-code, flow proceeds to block 612. As provided, the pre-existing code is less likely to be present for less-common, or unknown, sensors, such as may be the case with a barometer or barometric sensor, or other new and high-quality sensor of the add-on device 150.

At block 612, the processing unit 106 of the vehicle system 100 initiates or otherwise performs communication with the add-on device 150, for obtaining code relevant to forming the virtual I/O device file and driver 214, 216, such as via the channel shown schematically at reference numerals 550, 560 and/or 570. The control plane 230 can perform or manage the communications, by communicating with the control plane 430 of the add-on device 150 and/or other components of the add-on device 150, such as the I/O capability-mapping module 530.

As mentioned, the add-on device 150 typically would inherently have the device driver and file 416, 416, and accompanying code.

Transfer of the relevant driver and/or file code is indicated schematically by reference numeral 580. The transfer can form or be used to form the virtual I/O device driver 216, and the formation can also be considered indicated by the numeral 580.

A function of creating the virtual I/O device file can be performed based on the created virtual I/O device driver. File formation can be indicated by numeral 586.

As mentioned, in a contemplated embodiment, forming the client 212 and I/O device structures 214 216 is performed in response to a software upgrade or update received at the vehicle system 100 from the add-on device 300, such as by way of an application, configured in association with the present technology, received and operating at the add-on device 300.

At block 614, the processing unit 106 of the vehicle system 100 determines whether permission(s) exist or are sufficient to use the sensor-output from the add-on-device sensor(s) 328-336.

When the operation 614 results from block 610, the particular act 616 of obtaining permission(s) is expected to be, or will typically be, a relatively simple process, because the vehicle system 100 already had the underlying code obtained, or actuated, at block 610. The system 100 is thus pre-programmed to allow use of the contemplated sensor input being provided by the virtual arrangement—even if the contemplated sensor input was only expected to be via an more-expensive new actual-sensor input.

In the act 616, the processing unit 106 of the vehicle 102 in various embodiments executes control plane 230 functions, and leverages the mentioned permissions module 510 of the vehicle 102. The permissions module 510 can pre-exist at the vehicle 102, or be created or modified in the earlier-mentioned set-up operations (e.g., 606).

By way of examples, communications to check permissions are indicated by reference numerals 586, 582.

When the operation 614 results from block 612, the particular act 618 of obtaining permission(s) is expected to be a more-involved routine as compared with that of block 616. In various embodiments, the more-involved routine includes communications with the computer system 300 of the add-on device 150.

In the act 616, the processing unit 106 of the vehicle 102 in various embodiments executes control plane 230 functions, and leverages the mentioned permissions module 510 of the vehicle 102. The operations can also include the unit 106 communicating, via the processing unit 306 of the add-on device 150, such as with the control plane 430 of the add-on device 150, as indicated by path 560.

The processing unit 306, via the control plane 430, and in some cases a permissions module 520, of the add-on device 150, obtain instructions or data from storage of the system 300, such as from the operating system 400, that can be used to determine whether sufficient permission exists to use the sensor data from the add-on device for the virtual sensor arrangement at the vehicle 102.

By way of examples, paths for communications to check permissions are indicated by reference numerals 560, 588, 590, 592.

At diamond 620, capability of the add-on device 150, or particularly of the add-on device 150 with respect to providing subject add-on device sensor data, is analyzed to determine whether there is an appropriate match between the parameters by which the add-on device 150 provides sensor data and vehicle-system 100 configuration.

The consideration is in various embodiments performed by communications between the processing units 106, 306, by way of the respective control planes 230, 430. One or both planes 230, 430 can communicate with the I/O capability-mapping module 530, as indicated by paths 570, 592.

The decision 620 can include any of a wide variety of considerations without departing from the present disclosure. As examples, the decision can consider whether the speed or rate (e.g., sampling rate) by which add-on-device sensor data is output matches processing speeds, needs, or expectations at the vehicle system 100. Other example characteristics include latency, data-sensing accuracy, data format, and any other quality-of-service (QoS) parameters.

If at decision 620, the capabilities of the add-on device 150, or at least of the add-on device 150 as it pertains to output to the vehicle from a subject add-on-device sensor (e.g., smartphone barometer or camera), are determined insufficient (e.g., one or more critical aspects are insufficient), then the process can end 621, or be repeated 699 in connection with a different sensor of the add-on device 150, or with a different add-on device altogether. This result would follow because the vehicle system 100 is programmed with required parameters required for various functions. The data must be readable or recognizable, such as by being of a certain type. The data must be reliable and timely, such as by being received at rates and reliability or consistently over time appropriate to the level of importance—e.g., criticality—of the use at the vehicle 120. Virtual sensor data for use in autonomous driving must be sampled at a relatively high rate and received with relatively little latency, for instance, to be relied upon at the vehicle 102.

If at decision 620, the capabilities of the add-on device 150, or at least of the add-on device 150 as it pertains to output to the vehicle from the subject add-on-device sensor (e.g., smartphone barometer or camera), are determined in any aspect to be over-qualified, such as by too high of a sampling rate or too low of a latency, then flow proceeds to diamond 622 whereat the processing unit 106 of the vehicle system 100 communications (e.g., negotiates) with the processing unit 306 of the add-on device 150 to determine whether the add-on device 150 can degrade servers—e.g., deliver the subject sensor data with stated lower, target level(s) for the relevant aspect(s).

If at diamond 622 the vehicle system 100 determines that the add-on system cannot provide the subject sensor data with the target level(s) for the relevant aspect(s), flow could proceed to a contemplated decision operations 624 whereat the vehicle system 102 determines whether it is willing to operate above the target level.

If offending the target level only results in additional power usage, the vehicle system 102 can be programmed to at the operation 624 determine that the shortcoming can be overlooked, or at least overlooked dynamically, or adaptively, under certain circumstances, such as when a battery level at an electric vehicle 102 is above 50%, or battery level and expected trip or time to next charge, met pre-set criteria. As another example, the vehicle system 100 may be programmed so that, if offending a target capability level would result in use of additional memory, CPU processing, or wireless bandwidth usage at the system 100, the offense can be overlooked, or overlooked dynamically, such as when memory, CPU processing, or wireless bandwidth usage is sufficient or expected to be sufficient.

If offending the target is determine at operation 624 to be unacceptable, then the process can end 621, or be repeated 699 in connection with a different sensor of the add-on device 150, or with a different add-on device altogether.

If at decision 620, capabilities of the add-on device 150, or at least of the add-on device 150 as it pertains to output to the vehicle from the subject add-on-device sensor (e.g., smartphone barometer or camera), are determined to be satisfactory, or any parameter offending at target level is determined to be satisfactory, at least under present circumstances, at operation 624, flow proceeds to transition oval 625, leading to FIG. 7.

VII.B. Algorithm of FIG. 7

From transition oval 625 of FIG. 6, flow of the algorithm 700 of FIG. 7 begins 701.

Flow proceeds to block 702 where at sensor data is obtained by the vehicle system 100 from the add-on device 150. The operation 702 can include the vehicle system 100 requesting the data, such as in accord with a need communicated by the subject vehicle-side application(s) 270. Such request can be considered indicated by rightward flow at numeral 550 in FIG. 5.

The vehicle-system 100 processing unit 106 receives the data from the add-on-device-side server 412 by way of the vehicle-side client 212. The data path is indicated by leftward flow at numeral 550 in FIG. 5.

At block 704 the vehicle system 100 process the received sensor data using the virtual structures described. The operation 704 can be referred to as virtualizing the received sensor data. The operation 704 includes processing the received sensor data using the corresponding virtual I/O device driver and file 216, 214. In various embodiments, the processing results in data processed that can be presented the sensor data to the subject application 270 in the same, or substantially the same, manner (format, timing, etc.) that the application 270 would expect to receive such sensor data from an at-vehicle sensor (e.g., barometer), if the vehicle were equipped with such sensor (e.g., barometer).

The operations 704 include communications between the client and virtual I/O device file and/or driver 214, 216, as indicated schematically by path numeral 594 in FIG. 5, and functions performed at the virtual I/O device file and/or driver 214, 216, as indicated by numeral 595 in FIG. 5.

The operations 704 can include, for instance, open, read, configure, write, set, map, and callback functions, such as the following:

open (fd, permission)

read (buf, size);

write (buf, size);

configure (stat, val_{c})

set (par, valₛ);

mmap (fd, mem); and

callback (func(val));

wherein:
fd parameter is a file descriptor that indicates (virtual) I/O device file;
permission refers to an access and read/write right to this I/O device file;
buf indicates the address of the buffer used to contain the read and/or write operations;
size is the size of the buffer;
par is the particular parameter that needs to be set;
valₛ is a value of the setting (e.g., finite integer(s) or float numbers, such as 1, 5 or 30 fps, etc.);
val_{c} is a value of the configuration (e.g., finite string(s), such as “running”, “sleeping”, or “resetting”, etc.); and
mem refers to a memory page.

At block 706, the processed or virtualized sensor data is delivered to the subject application(s) 270. The path is shown by reference numeral 596 in FIG. 5.

At block 708, the application 270 uses the processed or virtualized sensor data, such as barometer data or camera data, in operations of the application 270, as if the sensor data originated form a vehicle sensor configured and arranged to provide the same data.

The operation 708 can include delivery of application output, indicated by path 598 in FIG. 8, to a receiving apparatus 540, such as a vehicle-user interface—e.g., heads-up display (HUD) or other screen, a vehicle speaker, a vehicle autonomous driving system, a vehicle HVAC system, a communication transceiver for sending a message to a remote device such as a remote customer-service (e.g., OnStar®) server or computer system.

The process 700 can end 709 or be repeated.

VIII. Barometer or Altimeter Use Case

As referenced above, along with other example use cases, such as using cameras and biometric sensors, add-on-device barometric sensor or barometric altimeters, could be leveraged at the vehicle 102 according to the present technology.

Applications using barometric data can perform functions including estimating road grade and creating or revising map data regarding elevation or altitude. The map data created or updated can be stored at the vehicle 102, at the add-on device 150 (e.g., smartphone), and/or remotely, such as a remote computing or server system 160. The remote system could use barometer or altimeter output from numerous devices over time to improve map data, effectively crowdsourcing a function that would otherwise require expensive professional survey work.

Road grade estimation can be valuable in vehicle operations such as powertrain-, or propulsion-, efficiency optimization and autonomous driving functions. Applications focused on these functions could use a virtual sensor, virtualizing a sensor the vehicle 102 doesn't already have, or virtualizing a sensor that is in one or more ways (e.g., accuracy) more advanced than a corresponding vehicle sensor.

Regarding propulsion-efficiency optimization, for instance, an application may be programmed to control vehicle functions, such as speed and acceleration as a function of present and imminent road grade. The functions require accurate road grade data, which is not always available in existing map data (e.g., satellite map data) or from an existing vehicle sensor.

Even for vehicles having a barometer, resolution or accuracy tends to be in the realm of about 100 Pa. Barometric sensors of modern smartphones are much more accurate, some having accuracy of about 1Pa, or better.

In one embodiment, the vehicle system 100 is programmed with an equation [Eqn. 1] using barometric pressure readings from the add-on device 150. The equation can be part of an application added to, or original to, the vehicle 102. The equation shown is an example and can be altered as desired, and/or another equation using barometer output can be implemented at the vehicle 102.

$$Sin β ( t ) = \frac{18400 ( 1 + \frac{a}{273} ) log \frac{{P}_{2} ( t + Δ t )}{{P}_{1} ( t )}}{\tilde{V} \cdot Δ t} \qquad [ Eqn . 1 ]$$

wherein:
   β(t) represents road grade angle, of the road segment, as a function of time (t) as a vehicle travels through the segment;
   a is a constant, used in barometer-estimated altitude measure;
   P₁ is barometer measurement at time t;
   P₂ is barometer measurement at time t+A t; and
   V is vehicle speed.

IX. Select Advantages

Many of the benefits and advantages of the present technology are described above. The present section restates some of those and references some others. The benefits described are not exhaustive of the benefits of the present technology.

As mentioned, the present technology by various embodiments leverages sensing capabilities of one or more mobile or otherwise connectable devices, such as a smart phone, at a vehicle such as an automobile, an aircraft, or marine craft.

The underlying architecture incorporates a plug-in or wireless sensor devices into vehicle operations. Benefits include but are not limited to improving vehicle performance of functions relying on sensor feedback, enhancing vehicle-user interaction, and/or enabling implementation at the vehicle of advanced computing applications requiring sensing capabilities that the vehicle would not have otherwise.

Capabilities of after-market, or on-the-road (OTR) vehicles can thus be enhanced with relative ease and at relatively low cost. Users are thus not limited to the sensing capabilities of the vehicle at the time it is originally manufactured.

In various embodiments, the technology allows relatively inexpensive addition of common, or known, sensors as well as less-common, uncommon, or unknown, sensors.

And the addition(s) can be performed without requiring changes to many, most or all primary on-board computer (OBC) features, such as vehicle operating system (OS) and original drivers—e.g., original vehicle sensor drivers.

The cost associated with effectively adding new sensor capabilities to an aftermarket, OTR, vehicle according to the present technology is much lower than the cost of retrofitting or upgrading the vehicle to include equivalent sensor hardware. Costs on the other hand of a retrofit include, for instance, labor, time, the new sensor hardware, and still other materials, such as mechanical and electrical connecting structures. Cost of implementing the present technology can be especially low when the user already has the add-on sensing device, such as if the device is an existing user phone.

X. Conclusion

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

References herein indicating direction are not made in limiting senses. For example, references to upper, lower, top, bottom, or lateral, are not provided to limit the manner in which the technology of the present disclosure can be implemented. While an upper surface may be referenced, for example, the referenced surface need not be vertically upward, in a design, manufacture, or operating reference frame, or above any other particular component, and can be aside of some or all components in design, manufacture and/or operation instead, depending on the orientation used in the particular application.

Directional references are provided herein mostly for ease of description and for simplified description of the example drawings, and the thermal-management systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface is referenced, for example, the referenced surface can, but need not be vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A transportation-vehicle system, for use in virtualizing sensor data from an add-on device for use by an application being executed at a transportation vehicle, comprising:
a hardware-based processing unit; and
a computer-readable storage device comprising:
a virtual-sensor-arrangement client configured to, when executed by the processing unit, communicate with a virtual-sensor-arrangement server of the add-on device, including receiving, from the virtual-sensor-arrangement server, the sensor data corresponding to sensing performed at a sensor of the add-on device, wherein the add-on device is not a part of the transportation vehicle as the vehicle was originally manufactured; and
a virtual input/output device driver configured to, when executed by the processing unit, process the sensor data received, yielding virtualized sensor data for delivery to the application being executed at the vehicle.

2. The transportation-vehicle system of claim 1, wherein the computer-readable storage device further comprises a control plane module configured to determine whether the sensor of the add-on is known or unknown to the transportation-vehicle system based on pre-established code of the transportation-vehicle system and:
if unknown, facilitate procurement from the add-on device of code configured to establish the virtual input/output device driver at the transportation-vehicle system;
if known, initiate establishment of the virtual input/output device driver at the transportation-vehicle system using the pre-established code.

3. The transportation-vehicle system of claim 1, wherein the computer-readable storage device further comprises a control plane module configured to communicate with an input/output capability-mapping module of the add-on device to determine whether the add-on device is configured to provide sensor output within one or more pre-established parameters of the transportation-vehicle system.

4. The transportation-vehicle system of claim 3, wherein the one or more pre-established parameters include at least one parameter selected from a group consisting of:
data-sampling rate;
data-sensing accuracy;
data-transmission latency;
data-transmission bandwidth; and
data format.

5. The transportation-vehicle system of claim 1, wherein the computer-readable storage device further comprises a control plane module configured to facilitate formation, at the transportation-vehicle system, of the virtual input/output device driver and a virtual input/output device file to store data processed by the virtual input/output device drive in operation of the transportation-vehicle system.

6. The transportation-vehicle system of claim 5, wherein the control plane, in being configured to facilitate formation of the virtual input/output device driver and the virtual input/output device file, is configured to determine whether an operating system associated with the transportation-vehicle system comprises code configured to establish the virtual input/output device driver and the virtual input/output device file.

7. The transportation-vehicle system of claim 6, wherein:
the control plane is a vehicle-system control plane; and
the vehicle-system control plane is configured to, in response to determining that the operating system does not comprise the code configured to establish the virtual input/output device driver and the virtual input/output device file, communicate with an add-on-device control plane to arrange transmitting, from the add-on-device to the transportation-vehicle system, code for establishing the virtual input/output device driver and the virtual input/output device file at the transportation-vehicle system.

8. The transportation-vehicle system of claim 1, wherein:
the computer-readable storage device further comprises a control plane module and a permissions module; and
the control plane is configured to, using the permissions module, determine whether permission exists to use, at the transportation-vehicle system, the sensor data from the add-on device.

9. The transportation-vehicle system of claim 8, wherein:
the control plane is a vehicle-system control plane, and the permissions module is a vehicle-system permissions module; and
the vehicle-system control plane is configured to, in determining whether permission exists to use the sensor data from the add-on device, communicate with an add-on-device control plane and add-on-device permissions module.

10. The transportation-vehicle system of claim 1, wherein the sensor is selected from a group consisting of:
an add-on-device barometer;
an add-on-device camera;
an add-on-device accelerometer;
an add-on-device gyroscope sensor;
an add-on-device biometric sensor;
an add-on-device microphone;
an add-on-device inertial-momentum unit;
an add-on-device geo-location receiver;
an add-on-device gyroscope sensor;
an add-on-device altimeter;
an add-on-device magnetometer;
an add-on-device proximity sensor;
an add-on-device light sensor;
an add-on-device touch sensor; and
an add-on-device wireless transceiver/detector.

11. A process, to be performed at a transportation vehicle comprising a virtual-sensor-arrangement client and a virtual input/output device driver, comprising:
executing, by a tangible transportation-vehicle system having a hardware-based processor executing instructions stored on a non-transitory computer-readable storage device, an application requiring input from a particularly type of sensor;
facilitating, by the tangible transportation-vehicle system, communication between the virtual-sensor-arrangement client, of the vehicle, and a virtual-sensor-arrangement server, of an add-on device, wherein the add-on device comprises an add-on-device sensor having the particularly type and is not a part of the transportation vehicle as the vehicle was originally manufactured;
obtaining, by the tangible transportation-vehicle system, from the add-on device, sensor output from the add-on-device sensor;
processing the sensor output, by the tangible transportation-vehicle system, using the virtual input/output device driver of the transportation vehicle, yielding virtualized sensor data; and providing the processed sensor data to the application as the input required.

12. The process of claim 11, wherein the transportation vehicle is not equipped with the particularly type of sensor from which the application needs input.

13. The process of claim 11, wherein:
the transportation vehicle comprises a virtual input/output device file; and
processing the sensor output, by the tangible transportation-vehicle system, comprises using the virtual input/output device file and the virtual input/output device driver of the transportation vehicle, yielding the virtualized sensor data.

14. The process of claim 11, further comprising communicating with an input/output capability-mapping module of the add-on device to determine whether the add-on device is configured to provide sensor output within one or more pre-established parameters of the transportation-vehicle system.

15. An add-on device, for use in virtualizing sensor data from a transportation-vehicle system for use by an application being executed at the add-on device, comprising:
a hardware-based processing unit; and
a computer-readable storage device comprising:
a virtual-sensor-arrangement client configured to, when executed by the processing unit, communicate with a virtual-sensor-arrangement server of the transportation-vehicle system, including receiving, from the virtual-sensor-arrangement server, the sensor data corresponding to sensing performed at a sensor of the transportation-vehicle system, wherein the add-on device is not a part of the transportation vehicle as the vehicle was originally manufactured; and
a virtual input/output device driver configured to, when executed by the processing unit, process the sensor data received, yielding virtualized sensor data for delivery to the application being executed at the add-on device.

16. The add-on device of claim 15, wherein the computer-readable storage device further comprises a control plane module configured to communicate with an input/output capability-mapping module of the transportation-vehicle system to determine whether the transportation-vehicle system is configured to provide sensor output within one or more pre-established parameters of the add-on device.

17. The add-on device of claim 15, wherein the computer-readable storage device further comprises a control plane module configured to facilitate formation, at the add-on device, of the virtual input/output device driver and a virtual input/output device file to store data processed by the virtual input/output device drive in operation of the add-on device.

18. The add-on device of claim 15, wherein:
the computer-readable storage device further comprises a control plane module and a permissions module; and
the control plane is configured to, using the permissions module, determine whether permission exists to use, at the transportation-vehicle system, the sensor data from the add-on device.

19. The add-on device of claim 18, wherein:
the control plane is an add-on-device control plane, and the permissions module is an add-on-device permissions module; and
the add-on-device control plane is configured to, in determining whether permission exists to use the sensor data from the transportation-vehicle system, communicate with a vehicle-system plane and add-on-device permissions module.

20. The add-on device of claim 15, wherein the sensor is selected from a group consisting of:
a transportation-vehicle-system radar;
a transportation-vehicle-system camera;
a transportation-vehicle-system accelerometer;
a transportation-vehicle-system gyroscope sensor;
a transportation-vehicle-system biometric sensor;
a transportation-vehicle-system barometer;
a transportation-vehicle-system speed or velocity sensor;
a transportation-vehicle-system microphone;
a transportation-vehicle-system inertial-momentum unit;
a transportation-vehicle-system geo-location receiver;
a transportation-vehicle-system gyroscope sensor;
a transportation-vehicle-system altimeter;
a transportation-vehicle-system magnetometer;
a transportation-vehicle-system proximity sensor;
a transportation-vehicle-system light sensor;
a transportation-vehicle-system touch sensor; and
a transportation-vehicle-system wireless transceiver/detector.
